(19) United States
(12) Patent Application Publication
(10) Pub. No.: US 2025/0377069 A1
(43) Pub. Date: Dec. 11, 2025

(54) MONITOR ARM

(71) Applicant: Human Active Technology, LLC, Easton, PA (US)

(72) Inventors: Stephen J. Bowman, Saylorsburg, PA (US); Shaun J. Smith, Harleysville, PA (US); Rustam Nasmit, Saylorsburg, PA (US)

(73) Assignee: Human Active Technology, LLC, Easton, PA (US)

(21) Appl. No.: 19/193,373

(22) Filed: Apr. 29, 2025

Related U.S. Application Data
(60) Provisional application No. 63/639,923, filed on Apr. 29, 2024.

(51) Int. Cl. F16M 11/10; F16M 11/20

(52) U.S. Cl. CPC F16M 11/105; F16M 11/2035; F16M 2200/06

(57) ABSTRACT

An adjustable rotation limiter for a monitor arm is disclosed. The monitor arm may include a base portion and a rotatable arm portion. The rotation limit system includes a rotation limit selector that is carried on either the base portion or the rotatable arm portion and includes a limit projection that extends parallel to an axis of rotation. A rotation limit bushing is carried on the other of the base portion or rotatable arm portion and includes an annular recess having a slot extending in a circular arc about the axis of rotation. The limit projection is slidably inserted into the slot to limit the extent of rotation of the rotatable arm portion with respect to the base portion.

### BACKGROUND OF THE INVENTION

The present invention relates to an apparatus, commonly called a monitor arm, that designed to support one or more electric displays. More particularly, the present invention relates to a device for limiting the rotation of a monitor arm arranged for engaging a user device such as a computer monitor, the monitor arm including a base portion and a rotatable arm portion or a monitor pole.

Frequently, a user device, such as a computer monitor or flat panel display is secured to a support surface, such as a desk or wall, via a monitor arm. The monitor arm may include a base portion mounted to a support surface such as a desk or wall, and a swiveling extension arm that connects the base portion to the user device so that the user device is movable with respect to the support surface. Once the user device is attached to the mounting apparatus, the user may be permitted to rotate the user device about an axis of rotation of the base. In such mounting apparatuses, however, there may be a need to limit the degree to which the user device is permitted to rotate, or there may be a need to prevent rotation entirely. In one example, it may be beneficial to limit rotation of the user device to prevent the user device from touching a back wall, or a left or right side wall during adjustment. Also, limiting the rotation of the user device may prevent the user device from reaching outside a service area into another service area, e.g., a service area of an adjoining desk.

### SUMMARY OF THE INVENTION

The invention relates generally to a system that limits relative rotational movement of a monitor arm that may include a base portion and a rotatable arm portion connected to the base portion. The system may include a rotation limit selector that is carried on either the base portion or the rotatable arm portion of the monitor arm and includes a limit projection that extends parallel to an axis of rotation. A rotation limit bushing is carried on the other of the base portion or rotatable arm portion of the monitor arm and includes a shoulder having a slot extending in a circular arc about the axis of rotation. The limit projection is slidably inserted into the slot to limit the extent of rotation of the rotatable arm portion with respect to the base portion.

### BRIEF DESCRIPTION OF THE DRAWINGS

The present invention will hereinafter be described in conjunction with the appended drawing figures wherein like numerals denote like elements.

FIG. 1 is a perspective view of a monitor arm assembly incorporating the adjustable rotation limiter of the present invention;

FIG. 2 is a perspective view of a rotation limit selector which is a component of the present invention;

FIG. 3 is an exploded perspective view of a monitor arm assembly incorporating the adjustable rotation limiter of the present invention;

FIG. 4 is an enlarged cross-sectional view of a portion of the second exemplary embodiment of the adjustable rotation limiter of the present invention;

FIG. 5 is an enlarged cross-sectional view of a portion of the first exemplary embodiment of the adjustable rotation limiter of the present invention;

FIG. 6 is diagram illustrating a 180-degree range of rotation of the first exemplary embodiment of the adjustable rotation limiter of the present invention;

FIG. 7 is a diagram illustrating a 360-degree range of rotation of the second exemplary embodiment of the adjustable rotation limiter of the present invention;

FIG. 8 is a diagram illustrating a 90-degree range of rotation of the first exemplary embodiment of the adjustable rotation limiter of the present invention;

FIG. 9 is an enlarged cross-sectional view of a portion of the first exemplary embodiment of the adjustable rotation limiter of the present invention;

FIG. 10 is an enlarged cross-sectional view of a portion of the first exemplary embodiment of the adjustable rotation limiter of the present invention;

FIG. 11 is an enlarged cross-sectional view of a portion of the first exemplary embodiment of the adjustable rotation limiter of the present invention;

FIG. 12 is an exploded perspective view of a monitor arm assembly incorporating the adjustable rotation limiter of the present invention;

FIG. 13 is an exploded perspective view of another monitor arm assembly incorporating the adjustable rotation limiter of the present invention;

FIG. 14 is an enlarged perspective view of a monitor arm assembly illustrating an adjustment tool used as part of the adjustable rotation limiter of the present invention;

FIG. 15 is an enlarged perspective view of a monitor arm assembly illustrating an adjustment tool used as part of the adjustable rotation limiter of the present invention;

FIG. 16 is an enlarged perspective view illustrating a storage area for the adjustment tool;

FIG. 17 is an enlarged perspective view of a portion of the first exemplary embodiment of the adjustable rotation limiter illustrating assembly of same;

FIG. 18 is an enlarged perspective view of a portion of the first exemplary embodiment adjustable rotation limiter;

FIG. 19 is a perspective view of a dual monitor arm assembly utilizing the adjustable rotation limiter of the present invention; and,

FIG. 20 is a perspective view of a portion of the dual monitor arm assembly utilizing the adjustable rotation limiter of the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

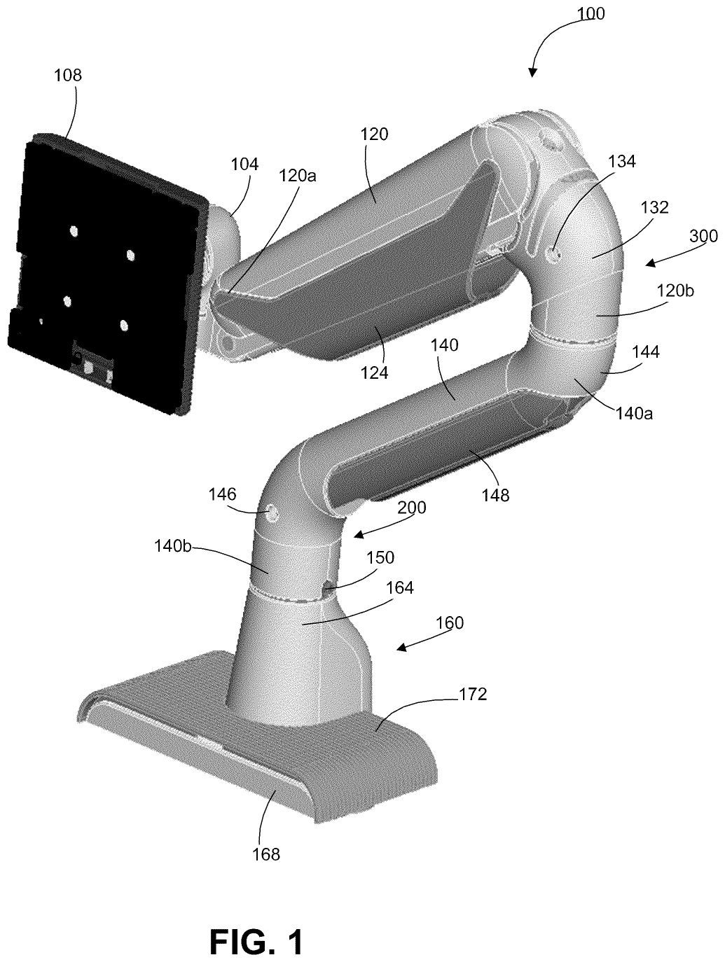

FIG. 1 illustrates an overall view of one possible configuration of a monitor arm assembly 100 on which the rotation limit system of the present invention could be utilized. The specific configuration of the monitor arm assembly 100 may be selected depending upon the particular type of workspace object it will connect to. For example, the monitor arm assembly 100 may include a base assembly 160 that is formed of a base casting 164 that is mounted to a base pad 168. The base pad 168 may include a cover 172. As best shown in FIG. 17, the monitor arm assembly 100 may include a clamp 186 provided as part of the base assembly 160 for clamping the monitor arm assembly 100 to the top of a desk or other horizontal surface. Alternatively, the clamp 186 can be employed to connect the monitor arm assembly 100 to a slat wall or other vertical surfaces.

A user device (not shown) may be secured to the monitor arm assembly 100 by securement to a plate assembly 108. The user device could be a conventional display screen such as a computer monitor. The plate assembly 108 may be secured to a tilt assembly 104 that is pivotable along a horizontal axis to enable a user to adjust a tilt angle of the user device once mounted to the plate assembly 108. The tilt assembly 104 may be mounted to the first end 120a of a dynamic arm assembly 120. The dynamic arm assembly 120 may include a casting 132 and a cable cover 124 for protecting cables. At its second end 120b, the dynamic arm assembly 120 is pivotably mounted to the first end 140a of an angled arm assembly 140 to form an upper joint 300. The angled arm assembly 140 may include a casting 144 and a cable cover 148. At its second end 140b, the angled arm assembly 140 is pivotably mounted to the base assembly 160 to form a lower joint 200.

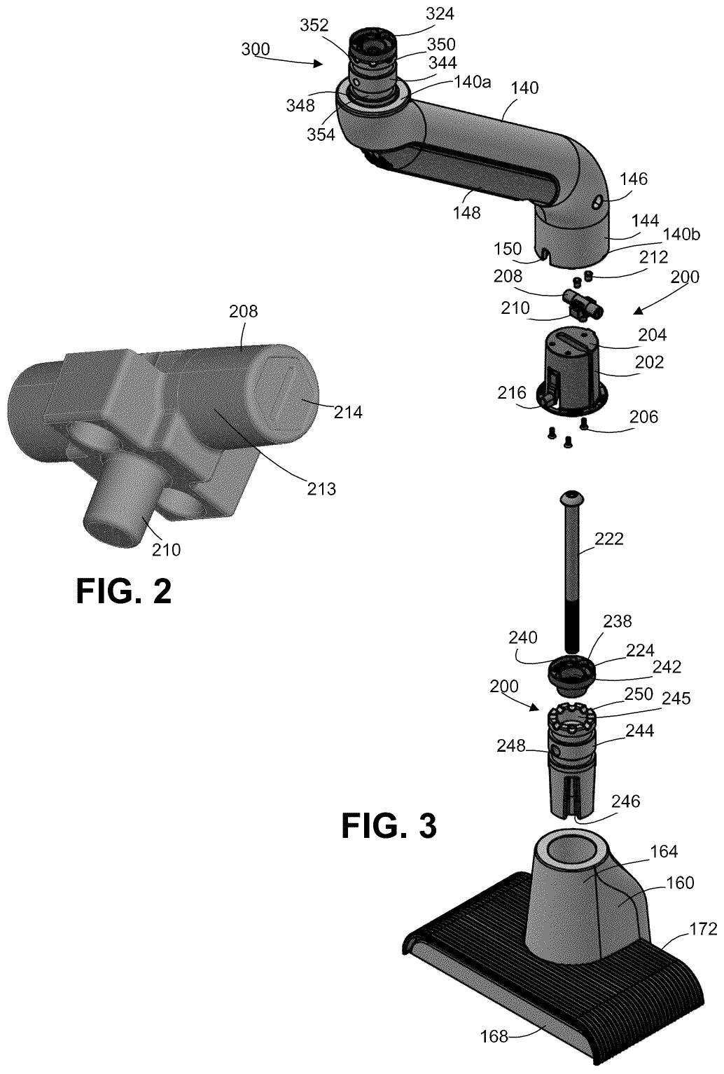

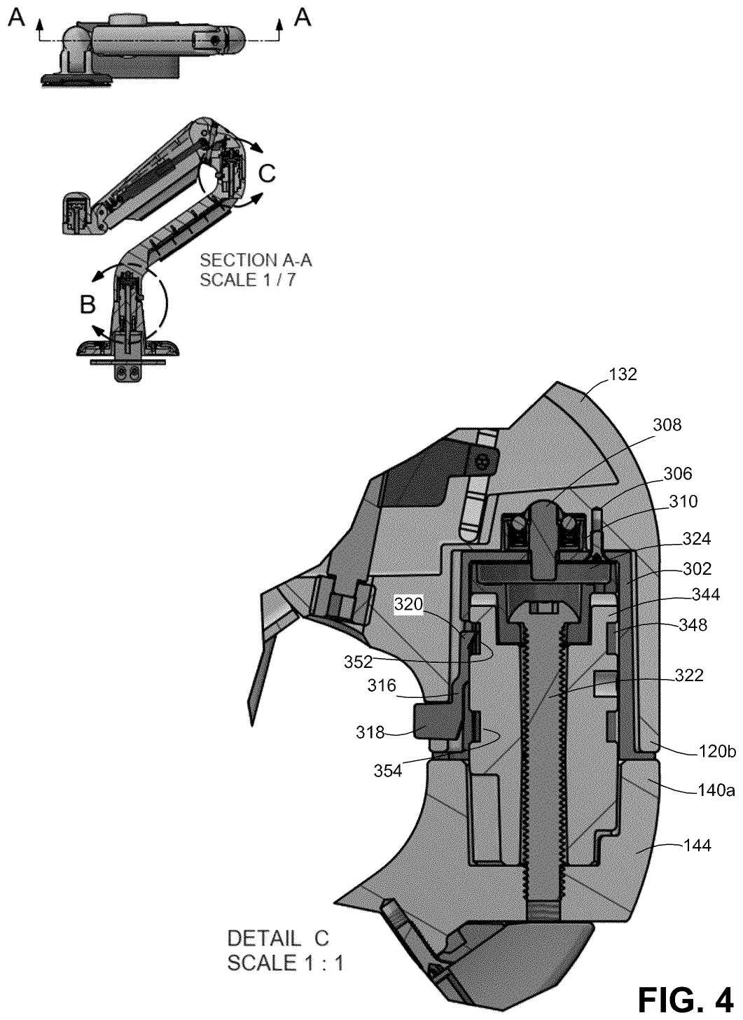

FIGS. 2, 3, and 5 illustrate the details of the rotation limit system of the present invention installed at the lower joint 200. In particular, the rotation limit system is comprised of four main components: a mount post 244, a rotation limit bushing 224, a locking bushing 202, and a rotation limit selector 208. As described in detail below, when the locking bushing 202 and rotation limit selector 208 are assembled to the second end 148b of the angled arm assembly 140, and the mount post 244 and rotation limit bushing 224 are assembled to the base assembly 160, these components interoperate to limit the degree of rotation of the angled arm assembly 140 with respect to the base assembly 160 to a greater or lesser extent based on user preference. Similarly, FIG. 4 illustrates the details of the rotation limit system of the present invention shown installed at the upper joint 300, which utilizes the same components as described above. When the locking bushing 302 and rotation limit selector 308 are assembled to the second end 120b of the dynamic arm assembly 120 and the mount post 344 and rotation limit bushing 324 are assembled to the first end 140a of the angle arm assembly 140, these components interoperate to limit the degree of rotation of the dynamic arm assembly 120 with respect to the angled arm assembly 140 to a greater or lesser extent based on user preference.

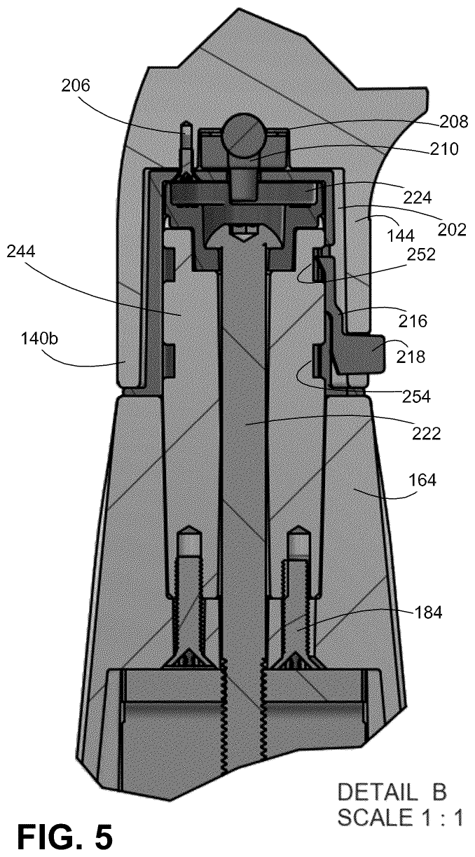

As best shown in FIGS. 3 and 5, at the lower joint 200, the mount post 244 includes one or more alignment features 246 to ensure that the mount post 244 is inserted in a particular rotational position within the central opening of the base casting 164 with the threaded hole 248 facing forward. The threaded hole 248 may be utilized to receive a set screw therethrough to secure the mount post 244 within the base casting 164. The mount post is secured within the central opening of the base casting 164 utilizing a plurality of mounting screws 184 which extend upwardly from the bottom of the base casting 164. Optionally, a plurality of upwardly facing protrusions (not shown) may be positioned at the bottom of the casting 164 to ensure that the mount post 244 will fully seat within the base casting 164 at only one rotational position. For example, four protrusions may be positioned equidistantly about the interior circumference of the base casting 164 and may include a pair of wider protrusions positioned adjacent a pair of narrower protrusions to ensure proper rotational positioning of the mount post 244.

Referring again to FIGS. 3 and 5, the rotation limit bushing 224 is provided with a shoulder portion surrounding a tube portion having a central opening 242 to enable seating within a central opening of the mounting post 244. As best shown in FIG. 3, the shoulder portion of the rotation limit bushing 224 includes a plurality of curved slots 238, 240 that extend about the central opening 242. For example, a first curved slot 238 may extend along a circular arc of approximately 180 degrees from a left stop located at one end of the arc to a right stop located at the opposite end of the arc. Similarly, a second curved slot 240 may extend along a circular arc of approximately 90 degrees between a left stop and a right stop. The length and number of the curved slots shown is merely exemplary and a greater or fewer number of curved slots having the same or different arc lengths could be used. As discussed in detail below, when selected, the first curved slot 238 provides a greater extent of rotation of the angled arm assembly 140 with respect to the base assembly, e.g., 180 degrees, and the second curved slot 240 a lesser extent of rotation, e.g., 90 degrees.

A threaded center bolt 222 is arranged to extend through the central opening 242 of the rotation limit bushing 224 and the central opening of the mount post 244 and secure to a threaded hole of the clamp 186 to retain the rotation limit bushing 224 and the mount post 244 tightly against the base casting 164. As illustrated in FIG. 17, an adjustment tool 190, e.g., a hex wrench, may be used for tightening these components. Together, the central openings of the mount post 244 and the rotation limit bushing 224 define an axis about which the angled arm assembly rotates with respect to the base assembly 160.

As best shown in FIG. 5, at the second end 140b of the angled arm assembly 140, the casting 144 is provided with an internal recess sized and shaped to house the locking bushing 202 and rotation limit selector 208. FIG. 3 shows that the locking bushing 202 is provided with a centrally located slot 204 and may be affixed within the casting 144 utilizing any suitable hardware, e.g., screws 206. FIG. 2 shows that the rotation limit selector 208 includes a cylindrical main body 213 having a hex fitting 214 at each end, and a cylindrical actuation element 210 that extends downwardly from the main body 213. When positioned within the casting 144, the main body 213 of the rotation limit selector 208 is captive within the through opening 146 on the casting 144 exposing the hex fittings 214 at each end, and the actuation element 210 extends through the slot 204 of the locking bushing 202 and into the shoulder portion of the rotation limit bushing 224 where the central opening 242 and curved slots 238, 240 are located.

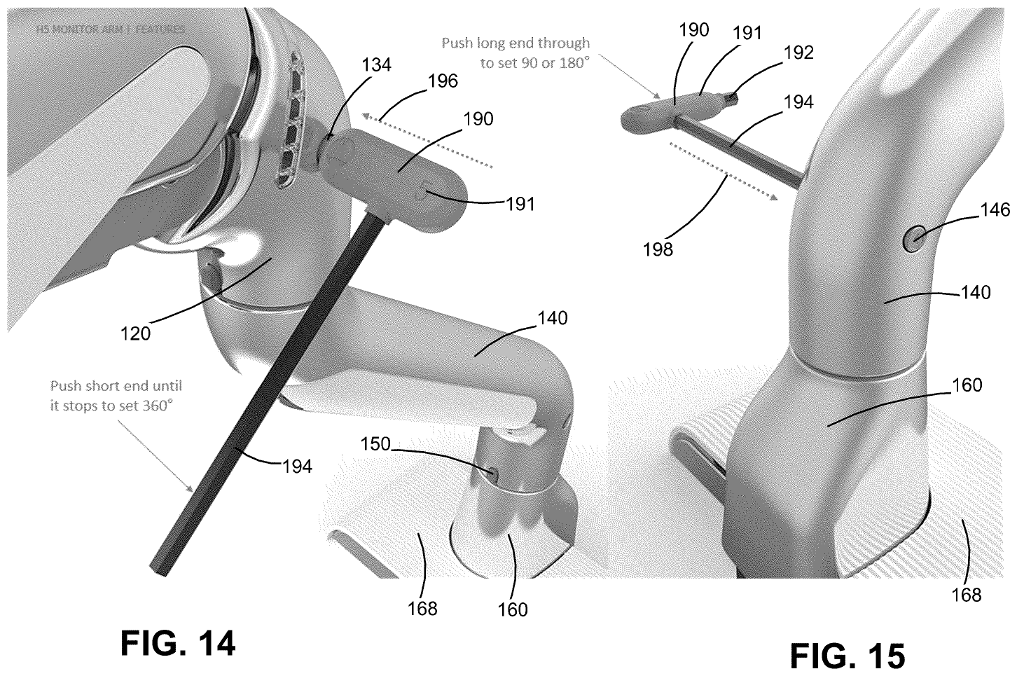

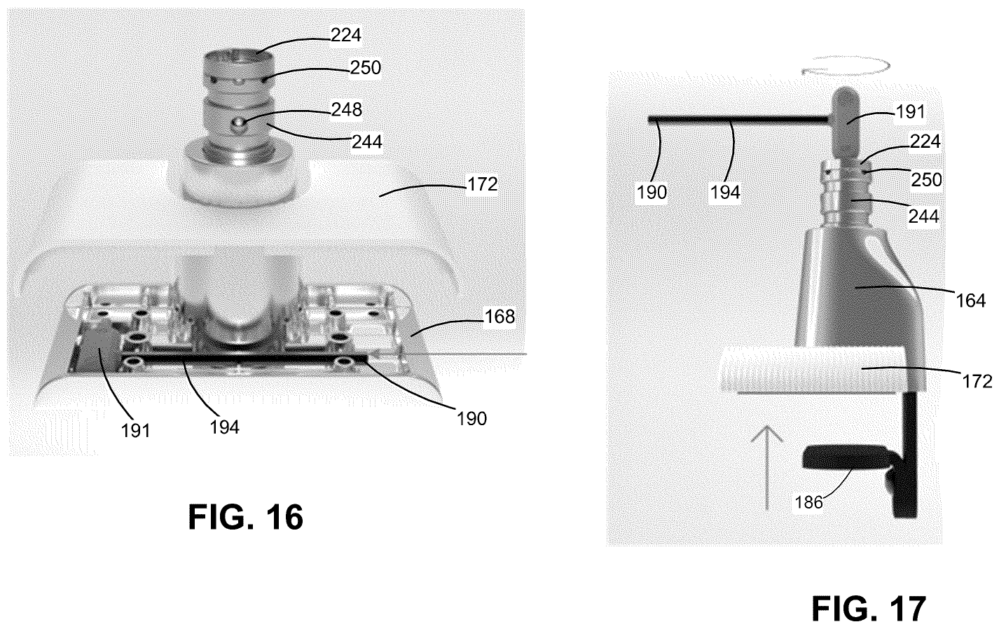

Referring now to FIGS. 14 and 15, an adjustment tool 190 is provided. The adjustment tool 190 includes a handle 191 having a short hex arm 192 extending in one direction and a long hex arm 194 extending in another direction from the handle 191. As shown in FIG. 16, the base assembly 160 includes an area for storage of the adjustment tool 190. Utilizing the adjustment tool 190, a user can slide the rotation limit selector 208 within the casting 164 into any one of three different positions, i.e., a central position, a left position, and a right position. Thus, the adjustment tool 190 can be used to perform nearly every adjustment function for the monitor arm assembly 100.

As shown in FIGS. 10 and 14, insertion of the short hex arm 192 into the through opening 146 of the casting 144 in the direction of arrow 196 causes the rotation limit selector 208 to slide into the central position and causes the actuation element 210 to insert into the central opening 242 of the rotation limit bushing 224. (Insertion of the short hex arm 192 from the opposite side also causes the rotation limit selector 208 to slide to the central position.) With the actuation element 210 inserted into the central opening 242, the angled arm assembly 140 is free to rotate a full 360 degrees with respect to the base assembly 160.

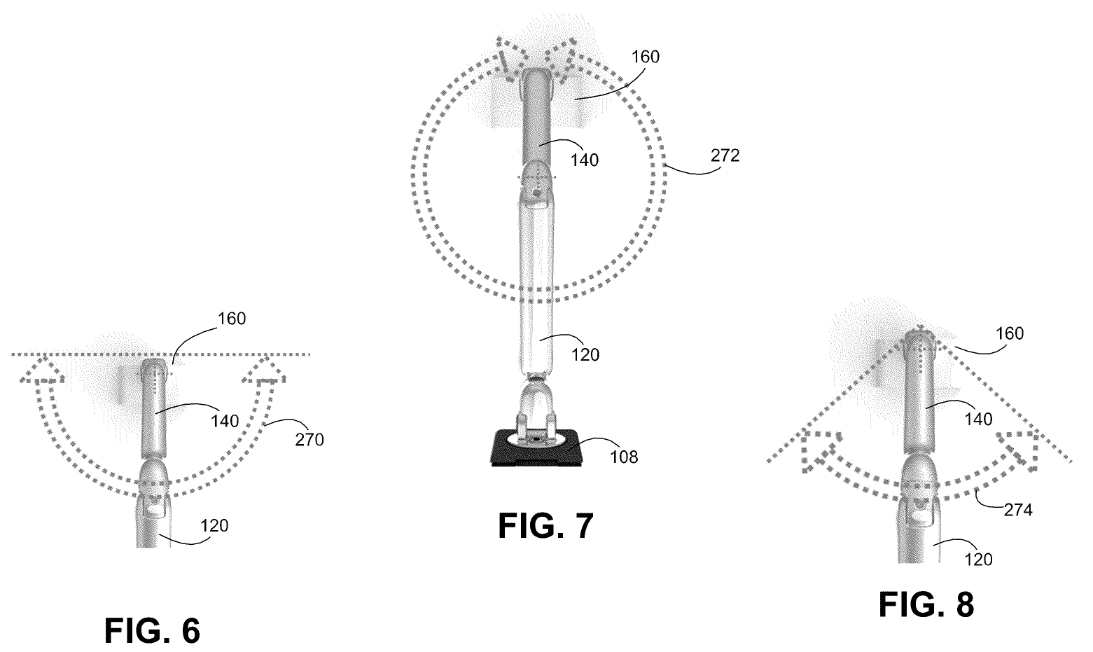

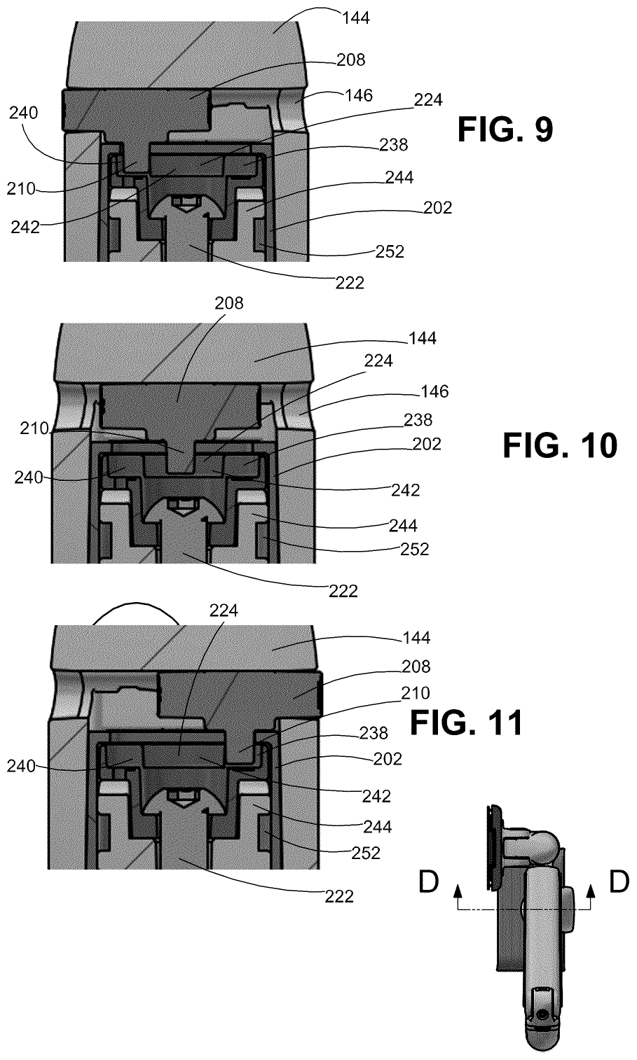

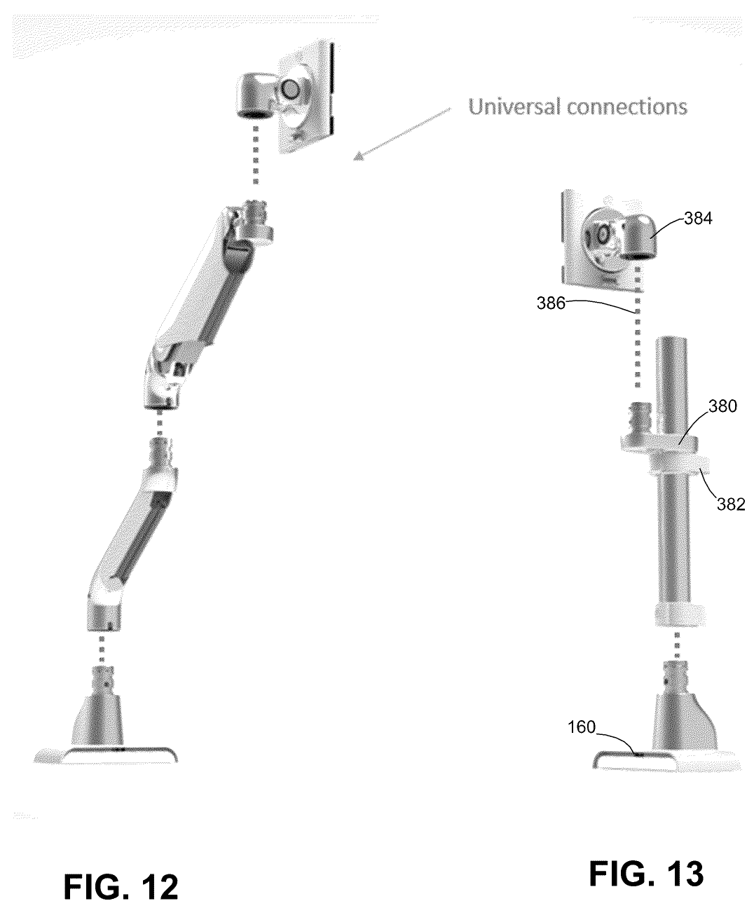

Referring now to FIGS. 9, 11, and 15, insertion of the long hex arm 194 into the through opening 146 in the direction of arrow 198 causes the rotation limit selector 208 to slide to the left position and causes the actuation element 210 to insert into the curved slot 238 (FIG. 11) of the rotation limit bushing 224. With the actuation element 210 inserted in the curved slot 238, the angled arm assembly 140 is limited to rotate 180 degrees with respect to the base assembly 160. FIG. 6 illustrates this range of rotation at arrow 270.

Insertion of the long hex arm 194 into the through opening 146 from the opposite side of the casting 144 in a direction opposite to arrow 198 causes the rotation limit selector 208 to slide to the right position and causes the actuation element 210 to insert into the curved slot 240 (FIG. 9) of the rotation limit bushing 224. With the actuation element 210 inserted in the curved slot 240, the angled arm assembly 140 is limited to rotate 90 degrees with respect to the base assembly 160. FIG. 8 illustrates this range of motion at arrow 274. The rotation limit selector 208 is provided with ball nose plungers 212 that apply a downward force on the actuation element as it moves across ramps and detents located on the shoulder of the rotation limit bushing 224.

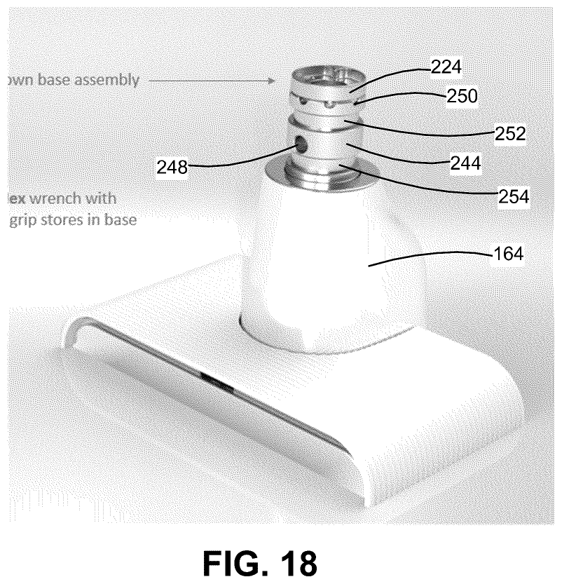

As best seen in FIGS. 3 and 16-18, the mounting post 244 is provided with a plurality of semicircular notches spaced equidistantly about its top edge. For example, as best shown in FIG. 3, eight notches are provided at 45-degree spaced intervals about the top edge of the mounting post 244. In this manner, the rotation limit bushing 224 may be oriented on the mounting post 244 to adjust the positions of the left and right stops of the curved slots 238 and 240 thus shifting the arc through which the angled arm assembly 140 rotates with respect to the base assembly 160.

As best seen in FIGS. 3 and 5, the locking bushing 202 is provided with a quick-release mechanism 216 including a push-button actuator 218 and a pivotable lever arm 220 having a catch 221 at a distal end. The mount post 244, over which the locking bushing 202 is assembled, is provided with an upper recess 252 to receive the catch 221, and a lower recess 254 to provide clearance when the push-button actuator 218 is depressed by the user. Once depressed, the catch 221 releases from the upper recess 252 enabling easy removal of the angled arm assembly 140 from the base assembly 160. Thus, the actuator 218, which enables disassembly of the joint is an integrally-formed part of the locking bushing 202. Utilizing the adjustment tool 190, the center bolt 222 may be loosened enabling adjustment of the orientation of the rotation limit bushing 224 on the mounting post 244 as discussed above. Once adjusted, center bolt 222 may be re-tightened and the angled arm assembly 140 reattached to the base assembly 160.

FIGS. 3 and 4 illustrate the details of the rotation limit system shown installed at the upper joint 300. In this embodiment, elements shared with the rotation limit system installed at the lower joint 200 are represented by reference numerals increased by factors of 100. For example, the rotation stop bushing 224 in FIG. 3 corresponds to the rotation stop bushing 324 in FIG. 4. In the interest of clarity, some features of this embodiment that are shared with the first embodiment are numbered in FIG. 4 but are not repeated in the specification.

Similar to the rotation limit system shown installed at the lower joint 200, the rotation limit system of the upper joint 300 is comprised of a mount post 344, a rotation limit bushing 324, a locking bushing 302, and a rotation limit selector 308. As best shown in FIG. 3, the mount post 344 is received within a recess of the casting 144 at the first end 140a of the angled arm assembly 140. The rotation limit bushing 324 is seated within the mount post 344. As best shown in FIG. 4, a threaded center bolt 322 extends through these components and into a threaded hole in the casting 144 to retain these components tightly against the casting 144. Thus, mount post 344 and the rotation stop bushing 324 are retained in the lower portion of the joint by the bolt 322, and the locking bushing 302 and the rotation limit selector 308 are retained in the upper portion of the joint.

As discussed above, the adjustment tool 190 may be used to tighten these components. At its lower end 120b, the casting 132 of the dynamic arm assembly 120 includes an internal recess sized and shaped to house the locking bushing 302, which may be retained therein using any suitable hardware, e.g., screws 306, and the rotation limit selector 308. When positioned therein, the rotation limit selector 308 aligns with a through opening 134 (FIG. 1) of the dynamic arm assembly 120.

Utilizing the adjustment tool 190 as described above, a user can slide the rotation limit selector 308 into any one of the three different positions discussed above, i.e., a central position, a left position, and a right position, each position corresponding with a different extent of rotation of the of the dynamic arm assembly 120 with respect to the angled arm assembly 140. FIG. 7 illustrates the 360-degree range of motion at arrow 272 when the rotation limit selector is slid to the central position.

In the interest of clarity, some features of this embodiment that are shared with the first embodiment are numbered in FIGS. 3 and 4 but are not repeated in the specification.

As demonstrated above, the rotation limit system is universal in that the same structure may be utilized in several different locations, i.e., the first joint 200, and the second joint 300. The same structure may also be utilized on other possible configurations of the monitor arm assembly. For example, FIG. 13 illustrates an overall view of another possible configuration of a monitor arm assembly which could include a vertically oriented pole 382 mounted to a base assembly 160. Carried on the pole 382 is a single yoke 380 in which the mounting post and rotation stop bushing of the rotation limit system of the present invention may be installed. The remaining components, i.e., the locking bushing and rotation limit selector, may be installed in the tilter 384 to limit rotational movement of the tilter 384 about a vertical axis 386.

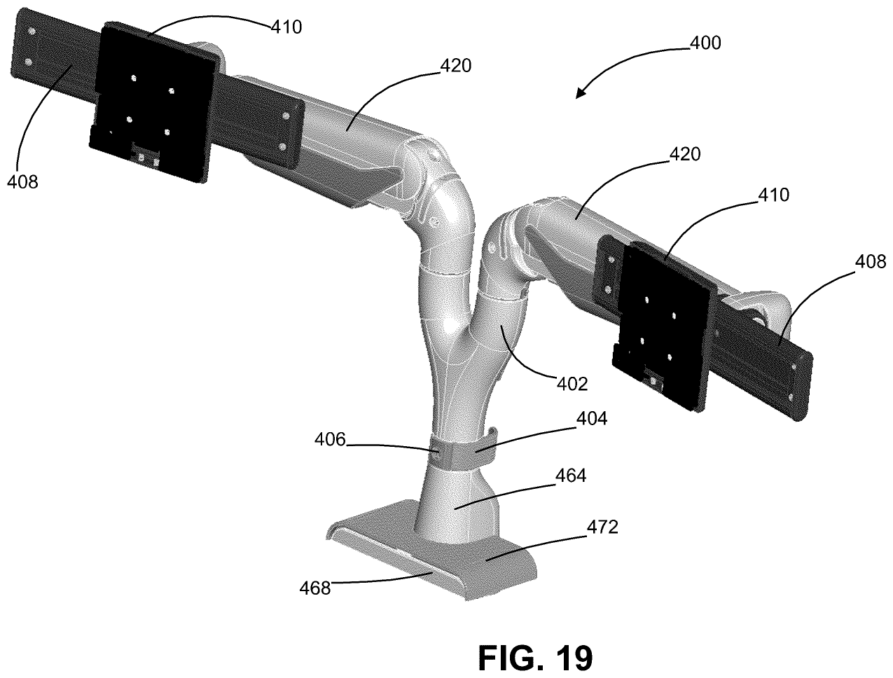

Likewise, FIG. 19 illustrates an overall view of another possible configuration of a monitor arm assembly 400 on which the rotation limit system of the present invention could be utilized. The monitor arm assembly 400 could include a Y-adapter casing 402 mounted to a base assembly formed of a base casting 464, a base pad 468, and a cover 472. At the top of each branch of the Y-adapter casing 402, a dynamic arm assembly 420 is rotatably mounted thereon. A slider track assembly 408 is shown mounted to each dynamic arm assembly 420. A user device (not shown), such as a conventional display screen or computer monitor, may be secured to a plate assembly 410 which is mounted to the slider track assembly 408.

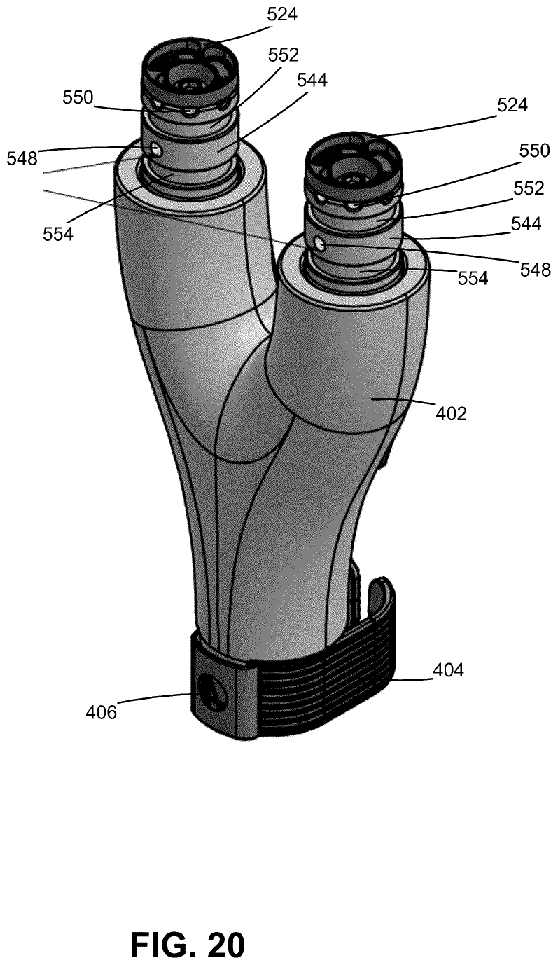

As best shown in FIG. 20, a mount post 544 and a rotation stop bushing 524 may be installed at each branch of the Y-adapter casing 402. The remaining components of the rotation limit system (not shown), i.e., the locking bushing and rotation limit selector, may be installed within the second end of the dynamic arm assembly 420 to limit rotation of the dynamic arm assembly 420 with respect to the Y-adapter casing 402.

The principles of the invention have been described above in connection with preferred embodiments, it is to be clearly understood that this description is made only by way of example and not as a limitation of the scope of the invention.

1. A monitor arm assembly for limiting the rotation of a user device, the monitor arm assembly comprising:
a. a base mount that is supportable from a support surface;
b. a base portion that extends upwardly from the base mount;
c. a first articulating arm rotatably connected at a first end thereof to the base portion about an axis of rotation; and,
d. a rotation limiting device situated between the base portion and the first articulating arm, the rotation limiting device comprising:
i. a rotation limit selector carried on the first end of the first articulating arm, the rotation limit selector including a limit projection extending parallel to the axis of rotation;
ii. a rotation limit bushing carried on the base portion, the rotation limit bushing including a shoulder portion having a slot extending in a circular arc about the axis of rotation; and,
iii. wherein the limit projection of the rotation limit selector is slidably insertable into the slot to limit the extent of rotation of the first articulating arm with respect to the base portion.

2. The monitor arm assembly of claim 1, the rotation limiting device further comprising a mount post, wherein the base portion includes a central opening arranged for receiving the mount post.

3. The monitor arm assembly of claim 2, the base portion further comprising an alignment feature requiring securement of the mount post within the central opening in only one orientation.

4. The monitor arm assembly of claim 3, the alignment feature further comprising a plurality of upwardly facing protrusions positioned within the base portion.

5. The monitor arm assembly of claim 2, wherein the rotation limit bushing is seated within an opening of the mount post.

6. The monitor arm assembly of 1, the rotation limit bushing further comprising a central opening, wherein the limit projection is insertable into the central opening.

7. The monitor arm assembly of claim 1, wherein the slot spans no more than 90 degrees about the axis of rotation.

8. The monitor arm assembly of claim 2, the rotation limiting device further comprising a locking bushing carried on the first end of the first articulating arm, the locking bushing including a central slot through which the limit projection extends.

9. The monitor arm assembly of claim 8, the locking bushing further comprising a release mechanism, wherein when the release mechanism is in an unactuated state, a catch on the release mechanism engages a recess on the mount post, and wherein when the release mechanism is actuated, the catch disengages from the recess.

10. The monitor arm assembly of claim 1, the monitor arm assembly further comprising a second articulating arm rotatably connected to a second end of the first articulating arm opposite the first end, and wherein the rotation limiting device is situated either between the base portion and the first articulating arm to limit the extent of rotation of the first articulating arm with respect to the base portion, or between the first articulating arm and the second articulating arm to limit the extent of rotation of the second articulating arm with respect to the first articulating arm.

11. The monitor arm assembly of claim 2, wherein the mounting post and rotation limit bushing are retained within the base portion by a center bolt.

12. The monitor arm assembly of claim 1, wherein the slot spans no more than 180 degrees about the axis of rotation.

13. The monitor arm assembly of claim 1, wherein the slot comprises a first slot spanning no more than 90 degrees about the axis of rotation and a second slot spanning no more than 180 degrees about the axis of rotation.

14. The monitor arm assembly of claim 1, wherein the user device is a computer monitor.

15. The monitor arm assembly of claim 1, the first articulating arm further comprising a through opening in which the rotation limit selector is retained.

16. The monitor arm assembly of claim 15, wherein the rotation limit selector is arranged to slide within the through opening to a plurality of positions.

17. The monitor arm assembly of claim 16, wherein the plurality of positions includes a central position, a left position, and a right position.

18. The monitor arm assembly of claim 1, the monitor arm assembly further comprising a second articulating arm rotatably connected to a second end of the first articulating arm opposite the first end, and wherein the rotation limiting device is situated between the base portion and the first articulating arm to limit the extent of rotation of the first articulating arm with respect to the base portion, and between the first articulating arm and the second articulating arm to limit the extend of rotation of the second articulating arm with respect to the first articulating arm.

19. A system to limit relative rotational movement between a first member and a second member about an axis of rotation, the system comprising:
a. a rotation limit selector carried on either one of the first or second members, the rotation limit selector including a limit projection extending parallel to the axis of rotation;
b. a rotation limit bushing carried on the other of the first or second members, the rotation limit bushing including a shoulder having a slot extending in a circular arc about the axis of rotation, and;
c. wherein the limit projection is slidably inserted into the slot to limit the extent of rotation of the first member with respect to the second member.

20. The system of claim 19, wherein the slot spans no more than 90 degrees about the axis of rotation.

21. The system of claim 19, wherein the slot spans no more than 180 degrees about the axis of rotation.

22. The system of claim 19, wherein the slot comprises a first slot spanning no more than 90 degrees about the axis of rotation and a second slot spanning no more than 180 degrees about the axis of rotation.

23. The system of claim 19, wherein the first and second slots are located at opposed locations on the rotation limit bushing.

24. The system of claim 23, wherein the rotation limit selector is slidable along a second axis perpendicular to the axis of rotation between a first position wherein the limit projection is slidably inserted in the first slot and a second position wherein the limit projection is slidably inserted in the second slot.

25. The system of claim 23, the shoulder further comprising a central opening positioned between the first and second slots, and wherein the rotation stop selector is slidable along the second axis to a third position wherein the limit projection is inserted into the central opening to provide up to 360 degrees of rotation of the first member with respect to the second member.

26. The system of claim 25, wherein the rotation limit selector is positioned above the rotation stop bushing with the limit projection extending downwardly and inserted into one of the central opening, the first slot, or the second slot.
